(19) United States
(12) Patent Application Publication
(10) Pub. No.: US 2015/0235527 A1
(43) Pub. Date: Aug. 20, 2015

(54) TRANSACTION PROCESSING SYSTEM AND TRANSACTION PROCESSING METHOD

(71) Applicant: Asda Stores Limited, Leeds (GB)

(72) Inventors: Alistair Maiden, Leeds (GB); Philip Tenney, Leeds (GB)

(21) Appl. No.: 14/619,986

(22) Filed: Feb. 11, 2015

(30) Foreign Application Priority Data
Feb. 14, 2014 (GB) 1402653.8

(51) Int. Cl. G07G 1/14; G06Q 20/20; G07G 1/00

(52) U.S. Cl. CPC G07G 1/145; G07G 1/0045; G06Q 20/208; G06Q 20/201

(57) ABSTRACT

A transaction processing system 100 includes a checkout 210 in a retail store 200. The checkout 210 is configured to obtain product data from a product database 240, e.g. from a store server over a network, in response to scanning the goods at the checkout 210. The checkout 210 is further configured to obtain price comparison information from a price comparison database 250 which compares prices of the scanned goods with prices of comparable goods offered by other retailers. The checkout 210 may be configured to display messages on a display 213 during the transaction, calculate payments which may include instantaneous discounts based on the price comparison information, and to receive payments from a customer for the basket of goods.

### RELATED APPLICATION

This application claims the benefit of Great Britain Application Serial No. 1402653.8 filed Feb. 14, 2014, which is hereby incorporated herein by reference in its entirety for all purposes.

### BACKGROUND

1. Technical Field

The present invention relates in general to the field of apparatus and methods for processing transactions in a retail store.

2. Description of Related Art

Typically, a customer collects a basket or trolley of goods in a retail store and then pays for those goods at a point of sale or checkout. It is known to print paper vouchers for the customer based on the value of the goods they have purchased, and/or based on one or more items included in their basket. These paper vouchers must be retained by the customer to be redeemed at a subsequent visit to the store. However, paper vouchers are relatively bulky and can be difficult to carry around. Customers frequently lose the paper vouchers, or forget to bring the paper vouchers back to the store, thus losing the benefit of their vouchers. Further, processing and redeeming the paper vouchers is relatively slow, which increases the total time taken for some transactions. Such delays can be inconvenient for customers and can add to the transaction processing costs for the store. These transaction processing delays can be particularly inconvenient during busy periods in the store.

The example embodiments aim to address at least some of these difficulties of the related art, or other difficulties as will be appreciated from the description below.

### SUMMARY OF THE INVENTION

According to the present invention there is provided a transaction processing system and transaction processing method for use in a retail store as set forth in the appended claims. Other, optional, features of the invention will be apparent from the dependent claims, and the description which follows.

There now follows a summary of various aspects and advantages according to embodiments of the invention. This summary is provided as an introduction to assist those skilled in the art to more rapidly assimilate the detailed discussion herein and does not and is not intended in any way to limit the scope of the claims that are appended hereto.

In one example there is provided a transaction processing system comprising: a checkout in a retail store configured to receive payments from a customer for a basket of goods; wherein the checkout is configured to obtain product data from a product database in response to scanning the goods at the checkout; and wherein the checkout is further configured to obtain price comparison information from a price comparison database which compares prices of the scanned goods with prices of comparable goods offered by other retailers.

In one example, the transaction processing system further comprises a store server which stores the product database and the price comparison database locally within the retail store. In one example, the checkout is configured to obtain the product data and the price comparison information in real time from the store server during a transaction in response to scanning one or more of the goods items.

In one example, the checkout may be configured to apply a discount to a basket total price for the basket of the goods based on the product data and the price comparison information. In one example, the checkout may be configured to apply the discount instantly within the current transaction.

In one example there is provided a method of processing a transaction in a retail store, comprising the steps of: scanning one or more product items at a checkout in the retail store; obtaining product data at the checkout relating to the scanned items; obtaining price comparison information at the checkout relating to the scanned items; and receiving a payment for the scanned items at the checkout.

In one example, the method includes calculating the payment to be received at the checkout based on both the product data and the price comparison information.

In one example, a tangible non-transient computer-readable storage medium is provided having recorded thereon instructions which, when implemented by a computer device, cause the computer device to be arranged as set forth herein and/or which cause the computer device to perform any of the methods as set forth herein.

### BRIEF DESCRIPTION OF THE DRAWINGS

For a better understanding of the invention, and to show how example embodiments may be carried into effect, reference will now be made to the accompanying drawings in which:

FIG. 1 is a schematic view of an example transaction processing system;

FIG. 2 is a schematic view of an example method of processing transactions.

### DETAILED DESCRIPTION OF THE EXAMPLE EMBODIMENTS

In the following description, reference is made to the accompanying drawings that form a part thereof, and in which is shown by way of illustration specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the scope of the present disclosure. The following detailed description is, therefore, not to be taken in a limiting sense.

Reference throughout this specification to “one embodiment,” “an embodiment,” “one example,” or “an example” means that a particular feature, structure, or characteristic described in connection with the embodiment or example is included in at least one embodiment of the present disclosure. Thus, appearances of the phrases “in one embodiment,” “in an embodiment,” “one example,” or “an example” in various places throughout this specification are not necessarily all referring to the same embodiment or example. Furthermore, the particular features, structures, databases, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

Embodiments in accordance with the present disclosure may be embodied as an apparatus, method, or computer program product. Accordingly, the present disclosure may take the form of an entirely hardware-comprised embodiment, an entirely software-comprised embodiment (including firmware, resident software, micro-code, etc.), or an embodiment combining software and hardware aspects that may all generally be referred to herein as a “circuit,” “module,” or “system.” Furthermore, embodiments of the present disclosure may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages. Such code may be compiled from source code to computer-readable assembly language or machine code suitable for the device or computer on which the code will be executed.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction and then scaled accordingly. A cloud model can be composed of various characteristics (e.g., on-demand self-service, broad network access, resource pooling, rapid elasticity, and measured service), service models (e.g., Software as a Service (“SaaS”), Platform as a Service (“PaaS”), and Infrastructure as a Service (“IaaS”)), and deployment models (e.g., private cloud, community cloud, public cloud, and hybrid cloud).

The flow diagrams and block diagrams in the attached figures illustrate the architecture, functionality, and operation of possible implementations of systems, methods, and computer program products according to various embodiments of the present disclosure. In this regard, each block in the flow diagrams or block diagrams may represent a module, segment, or portion of code, which comprises one or more executable instructions for implementing the specified logical function(s). It will also be noted that each block of the block diagrams and/or flow diagrams, and combinations of blocks in the block diagrams and/or flow diagrams, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flow diagram and/or block diagram block or blocks.

At least some of the following example embodiments provide an improved transaction processing system. Many other advantages and improvements will be discussed in more detail below, or will be appreciate by the skilled person from carrying out example embodiments based on the teachings herein.

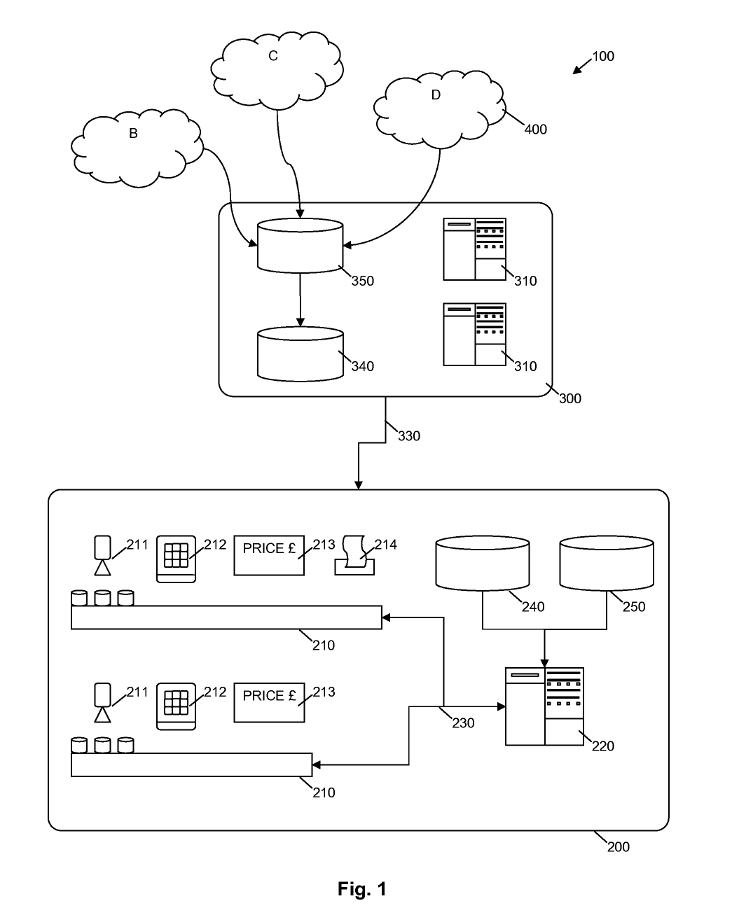

FIG. 1 is a schematic view of an example transaction processing system 100. Conveniently, the transaction processing system 100 is adapted for use in at least one retail store 200 where goods are chosen by the customer and paid for at a point of sale terminal or checkout 210. The customer typically places their chosen goods into a trolley, basket or other carrier while moving around the store. A basket of goods thus refers to a collection of one or more items which are to be purchased in the current transaction. Each store 200 suitably includes several such checkouts 210, as will be familiar to those skilled in the art. The checkouts 210 can be operated by employees of the store, and/or may be self-checkout terminals intended to be operated by the customer themselves, usually under supervision by the store employees. Each checkout 210 may include a scanner 211, such as a bar-code reader, to identify the goods being purchased. The checkout 210 may include a payment mechanism 212 to receive payments, such as a card reader and/or a cash drawer. The checkout 210 may include one or more display screens 213 which provide visual feedback to the store employees and/or the customers during each transaction. The checkout 210 may include a printer 214 to print a till receipt and other information to be carried away by the customer.

In this example, each store 200 includes one or more local store servers 220 which are linked to the checkouts 210 by a local communication network 230. The local area network 230 may take any suitable form, including secure wired and/or wireless communication links, as will be familiar to those skilled in the art. The store server 220 may hold a local product database 240 with information about each of the products offered by the store. The product database 240 suitably holds identifiers for product items (e.g. stock keeping units SKUs), pricing information, current offers or discounts (e.g. multi-buy offers), and so on.

One or more master servers 310 may be linked to each store 200 over one or more wide areas networks 330, which may take any suitable form including wired and/or wireless communication links, as will be familiar to those skilled in the art. In one example, the wide area network 330 may include a virtual private network VPN over the Internet, or dedicated leased lines. The master servers 310 may be located, for example, at one or more central or regional data processing sites 300 operated by the retailer. The master servers 310 may hold a main product database 340 as a master record of the products offered by the retailer in their stores. The master servers 300 may post updates to each store 200, e.g. each night or several times each day, thereby providing current information from the main product database 340 to update each local product database 240.

During a transaction, each product item which passes the scanner 211 at the checkout 210 triggers a lookup of respective price data from the local product database 240. In the example embodiment, the checkout 210 sends the product identifier of the scanned product over the local network 230 to the store server 220. The corresponding price data and product information from the local product database 240 is returned to the checkout 210 and may be displayed on the display 213 by way of confirmation. Conveniently, the checkout 210 includes a data processing and data storage capability to monitor the current transaction and, inter alia, maintain a running total of the plurality of items within the current transaction. In one example, the checkout 210 thus calculates a final total basket price, ready to receive payment via the payment mechanism 212 to complete the transaction. Suitably, the checkout 210 posts details of the completed transactions to the local store server 220 for reporting and accounting within the store, and the many transactions within each store are uploaded and reported from the store 200 back to the data processing centre 300.

There is an increasing desire to offer price transparency to the customer. Further, there is an increasing desire to allow customers to compare the prices of several different retailers. Typically, price comparison websites offer an interface via the Internet which allows the price of certain goods to be compared between several retailers. However, to make a price comparison, the customer must visit the website via an Internet-connected device such as a laptop or tablet computer, and carefully select the items of interest. Notably, it is relatively difficult and inconvenient to use a price comparison website while the customer is actually within the retail store. Hence, price comparison websites tend to be restricted in use only to a select group of customers who have the interest, ability and time to use those websites. Also, price comparison is typically performed while at home or otherwise away from the retail stores.

In the example embodiment, the transaction processing system 100 further comprises a price comparison database 350 which compares the prices of one or more products offered by the retailer with the price of one or more comparable products offered by other retailers. In this example, the main servers 310 of the data processing centre store one or more master copies of the price comparison database 350. The master price comparison database (or databases) 350 may, for example, be created by robotically crawling online web-shopping data from the online stores of the other retailers, or by manually observing and entering relevant price data.

In the example embodiment, the price comparison database 350 is distributed to the stores 200 over the wide area network 330 to form a local price comparison database 250 held locally within each store 200. Thus, each store 200, holds and has online real-time access to the product information and price data of the retailer (e.g. retailer A) and of the comparable other retailers (retailers B, C and D, for example), as held in the local product database 240 and the local price comparison database 250.

A difficulty arises in that the time taken to complete each transaction is a source of inconvenience for customers, especially at busy times when customers may have to queue at the checkouts 210. Also, transaction delay is a significant potential cost overhead for the store, considering that transaction throughput is important in determining the number of checkouts that need to be provided and operated, and the specification (capacity) of each checkout. Therefore, there is a need to improve transaction processing while maintaining acceptable transaction times.

In one example, the checkout 210 is configured to obtain price comparison data from the local price comparison database 250 for one or more of the scanned items. The checkout may obtain the price comparison data in real time, alongside obtaining the product data for that item.

In one example, the checkout 210 obtains the price comparison data separately for each line item within the transaction. A line item may comprise a plurality of individual scanned items (e.g. 6 individual bottles of a particular product may equate to one line item). As a result, the total transaction time is maintained to be relatively short in duration.

In one example, the checkout 201 is configured to calculate a price comparison result based on the obtained product data and price comparison information. The checkout 210 may display a message to the customer on the display 213 during the transaction based on the price comparison result. For example, the display 213 may present an appropriate message, such as “your product item XX is ££ cheaper with us today” or “we are cheaper than rivals B, C or D for your product XX”. In another example, these messages may be presented to the customer on their printed till receipt produced by the checkout 210.

In one example, the checkout 210 is configured to obtain the price comparison data for each of a plurality of items within a transaction, and to calculate a plurality of candidate basket totals. Each candidate basket total may be calculated, for example, by using the price data of a certain retailer. Suitably, each candidate basket total represents the price of that basket of items according to the price comparison data. The checkout 210 is suitably configured to compare the plurality of candidate basket totals and display an appropriate comparison result on the display screen 213 (e.g. “your basket total is ££ cheaper with us today”).

In one example, the checkout 210 may be configured to select the lowest basket total amongst the plurality of basket totals as the final basket total of the current transaction. In this example, the checkout 210 may be configured to display an appropriate message (e.g. “we have matched our prices for this basket to those of retailer C”).

In a further example, the checkout 210 is configured to calculate a discount based on comparing the plurality of basket totals. The checkout 201 may apply the discount to one or more of the basket totals in order to calculate a final basket total fro the current transaction. For example, the discount may be calculated according to the difference in price between one retailer and another. The discount may be a fixed rate (e.g. 10 pence per item) or a percentage (e.g. 50% of the difference between our price and the price of the nearest other retailer).

In one example, the checkout 210 is configured to apply the discount instantly during the current transaction. As a result, the customer instantly receives the financial benefit of the discount, which may be derived from the price comparison data as described above. Applying an instantaneous discount within the current transaction gives immediate benefit for the customer, reduces the previous need to issue and redeem paper vouchers, and reduces transaction times for the retailer.

In one example, the calculation may include caps or restrictions which limit the calculation based, for example, on weight or quantity of the items. For example, the checkout may be configured to require a minimum or maximum number of items in the basket, or a minimum or maximum number of certain items. In one example, these caps and restrictions are supplied using appropriate qualification fields carried within the product data and/or in the price comparison information obtained by the checkout in response to scanning the goods. In one example, the qualification fields are dynamically adjustable, allowing the transaction system to respond to rapidly changing retail conditions.

In one example, the price comparison database 250 and the local product database 240 may be held as distinctly separate databases linked by one or more common indexing fields such as the product identifier (e.g. the SKU). In another example, a single database may be used to combine both the retailer's own product data and the price comparison data within a combined data structure.

In one example, the product database 240 and/or the price comparison database 250, or certain subsections thereof, may be distributed on any suitable physical components of the system 100. For example, portions of these databases may be held or cached locally within each checkout 210. Such distributed databases may take any suitable form and be subject to purging, reconstruction, updating, recovery, failover and load-balancing as will be familiar to those skilled in the art.

Although the example embodiments have been illustrated with the checkout 210 performing certain tasks, other embodiments may instead cause the described processing steps to be taken by other equipment, e.g. by the store server 220. In one example, the checkout 210 may act as a relatively dumb terminal interface to receive inputs such as from the scanner 211, transmit information to the store server 220, receive replies and make appropriate outputs such as via the displays 213.

In another example embodiment, the checkout 210 may be, or may comprise, a portable or hand-held terminal suitable to be moved or carried around the retail store. The portable checkout terminal may include a bar-code reader, e.g. a camera, and a user interface, e.g. a display screen. A payment mechanism may be implemented by the terminal, e.g. by the customer inputting payment account details or otherwise connecting the terminal to a payment system. Equipment brought to the store by the customer may be operated as the checkout or may contribute to operation of the checkout, such as a mobile phone or other computing device.

The example embodiments have been described with reference to messages which are displayed on the display 213 and/or printed on a till receipt by the checkout 210 using a suitable printer 214. Other specific forms of providing such messages to the customer are also envisaged including, but not limited to, communicating with the customer electronically, e.g. by text message or email, to display the message on the customer's own device, such as their mobile phone.

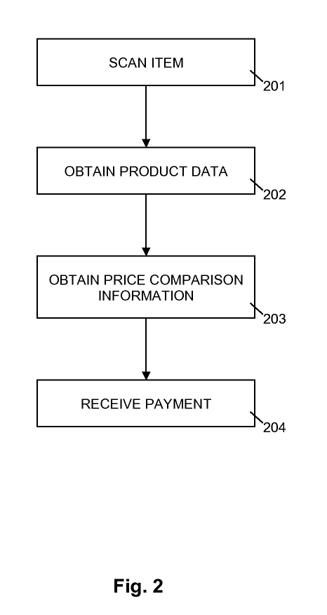

FIG. 2 is a flowchart of an example method. In the example embodiments, the method may be implemented as described in detail above.

Step 201 comprises scanning one or more product items at a checkout in the retail store, by the checkout 210.

Step 202 comprises obtaining product data at the checkout 210 relating to the one or more scanned items.

Step 203 comprises obtaining price comparison information at the checkout 210 relating to one or more of the scanned items.

Step 204 comprises calculating a final payment to be received at the checkout for the scanned items. The final payment for this basket of items may be based on both the product data and the price comparison data, as explained above.

At least some of the example embodiments described herein may be constructed, partially or wholly, using dedicated special-purpose hardware. Terms such as ‘component’, ‘module’ or ‘unit’ used herein may include, but are not limited to, a hardware device, such as circuitry in the form of discrete or integrated components, a Field Programmable Gate Array (FPGA) or Application Specific Integrated Circuit (ASIC), which performs certain tasks or provides the associated functionality. In some embodiments, the described elements may be configured to reside on a tangible, persistent, addressable storage medium and may be configured to execute on one or more processors. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example embodiment may be combined with features of any other embodiment, as appropriate, except where such combinations are mutually exclusive. Throughout this specification, the term “comprising” or “comprises” may mean including the component(s) specified but is not intended to exclude the presence of other components.

Although a few example embodiments have been shown and described, it will be appreciated by those skilled in the art that various changes and modifications might be made without departing from the scope of the invention, as defined in the appended claims.

1. A transaction processing system, comprising:
a checkout for a retail store, wherein the checkout is configured to receive payments from a customer for a basket of goods;
wherein the checkout is configured to obtain product data from a product database in response to scanning the goods at the checkout; and
wherein the checkout is further configured to obtain price comparison information from a price comparison database which compares prices of the scanned goods with prices of comparable goods offered by other retailers.

2. The transaction processing system of claim 1, further comprising:
a store server coupled to the checkout by a network, wherein the store server is arranged to store the product database and the price comparison database locally within the retail store, and to supply the product data and the price comparison information to the checkout over the network.

3. The transaction processing system of claim 2, wherein:
the checkout is configured to obtain the product data and the price comparison information in real time from the store server during a transaction in response to scanning one or more of the goods items.

4. The transaction processing system of claim 2, wherein:
the checkout is configured to obtain a basket total price for the basket of the goods based on the product data and the price comparison information.

5. The transaction processing system of claim 4, wherein:
the checkout is configured to apply a discount instantly within the current transaction to the basket total price for the basket of the goods based on the product data and the price comparison information.

6. The transaction processing system of claim 1, wherein the checkout comprises:
a scanner to scan the items of the basket of goods being purchased in a transaction;
a payment mechanism to receive a payment for the basket of goods;
a display screen to provide visual feedback during the transaction;
a processor to control the checkout during the transaction; and
a memory to store data and information relevant to the transaction.

7. The transaction processing system of claim 6, wherein the checkout is configured to:
scan one or more of the items using the scanner; and
obtain the product data and the price comparison data for one or more of the scanned items.

8. The transaction processing system of claim 7, wherein the checkout is configured to obtain the price comparison data in real time, alongside obtaining the product data for the item.

9. The transaction processing system of claim 8, wherein the checkout is configured to obtain the price comparison information separately for each line item within the transaction, wherein the line item comprises one or more individual items.

10. The transaction processing system of claim 1, wherein the checkout is configured to calculate a price comparison result based on the obtained product data and price comparison information.

11. The transaction processing system of claim 10, wherein the checkout is configured to display a message during the transaction based on the price comparison result.

12. The transaction processing system of claim 1, wherein the checkout is configured to obtain the price comparison information for each of a plurality of items within the basket of goods, wherein the basket of goods also contains one or more other items, and to calculate a plurality of candidate basket totals for the basket of goods containing the plurality of items.

13. The transaction processing system of claim 12, wherein each candidate basket total uses the price data of a certain retailer for the plurality of items.

14. The transaction processing system of claim 12, wherein the checkout is configured to compare the plurality of candidate basket totals and determine the price comparison result based on the comparison.

15. The transaction processing system of claim 1, wherein the checkout is configured to store a local cache of the product data and the price comparison information for use in a plurality of transactions at the checkout.

16. A method of processing a transaction in a retail store, comprising:
scanning one or more product items at a checkout in the retail store;
obtaining product data at the checkout relating to the scanned items;
obtaining price comparison information at the checkout relating to the scanned items; and
receiving a payment for the scanned items at the checkout.

17. The method of claim 16, further comprising:
calculating the payment to be received at the checkout based on both the product data and the price comparison information.

18. The method of claim 16, comprising calculating the payment including an instantaneously applied discount based on the product data and the price comparison information.

19. A non-transient tangible computer readable medium having instructions recorded thereon which when executed cause a checkout for a retail store to perform the steps of:
scanning one or more product items at a checkout in the retail store;
obtaining product data at the checkout relating to the scanned items;
obtaining price comparison information at the checkout relating to the scanned items; and
receiving a payment for the scanned items at the checkout.

20. The computer readable medium of claim 19, wherein the steps further comprise:
calculating the payment to be received at the checkout based on both the product data and the price comparison information.
